(19) United States
(12) Patent Application Publication
(10) Pub. No.: US 2021/0191387 A1
(43) Pub. Date: Jun. 24, 2021

(54) SYSTEM AND METHOD FOR ASSISTED TELEOPERATIONS OF VEHICLES

(71) Applicant: Autonomous Solutions, Inc., Mendon, UT (US)

(72) Inventors: Walter Gunter, Mendon, UT (US); Matthew Droter, Mendon, UT (US); Daniel John Morwood, Petersboro, UT (US); Bret Todd Turpin, Wellsville, UT (US)

(21) Appl. No.: 16/725,724

(22) Filed: Dec. 23, 2019

(51) Int. Cl. G05D 1/00; B60W 30/18; B60W 10/04; B60W 10/18; B60W 10/20

(52) U.S. Cl. CPC G05D 1/0011; B60W 30/18; B60W 10/04; B60W 10/18; B60W 2710/20; B60W 2555/60; B60W 2720/106; B60W 2710/18; B60W 10/20

(57) ABSTRACT

A vehicle system includes at least one sensor and a communications system configured to receive one or more remote operations commands. The vehicle system further includes control system configured to execute a speed control system to control a speed of the vehicle system. The control system is further configured to execute an automatic adjustment teleoperations system to derive a filtered speed command based on the one or more remote operations commands and the at least one sensor, and to adjust the speed of the vehicle system based on the filtered speed command.

### BACKGROUND

The invention relates generally to a teleoperations of vehicles, and more specifically, to assisted teleoperation of vehicles.

Certain vehicles may operate via control systems that direct the steering of vehicles remotely. For example, certain construction vehicles, agricultural tractors, and the like, may include teleoperated steering systems suitable for steering the vehicles from a remote location. Generally, the vehicle, such as the agricultural tractor, may be sent driving inputs provided by a remote operator. Accordingly, the control system, such as an electronic control system, may be used to control and/or otherwise steer the autonomous vehicle based on the remote inputs. The agricultural tractor may thus be steered through a field. It would be beneficial to improve on teleoperation of vehicles. As a result of improved teleoperations, the vehicle may improve drive times and enhance operational efficiency.

### BRIEF DESCRIPTION

In one embodiment, a vehicle system includes at least one sensor and a communications system configured to receive one or more remote operations commands. The vehicle system further includes control system configured to execute a speed control system to control a speed of the vehicle system. The control system is further configured to execute an automatic adjustment teleoperations system to derive a filtered speed command based on the one or more remote operations commands and the at least one sensor, and to adjust the speed of the vehicle system based on the filtered speed command.

In another embodiment, a method includes receiving one or more remote operations commands via a communications system included in a vehicle system. The method further includes executing, via a control system included in the vehicle system, a speed control system to control a speed of the vehicle system. The method also includes executing, via the control system, an automatic adjustment teleoperations system to derive a filtered speed command based on the one or more remote operations commands and at least one sensor, and adjusting, via the control system, the speed of the vehicle system based on the filtered speed command.

In a further embodiment, a non-transitory, computer readable medium comprises instructions that when executed by a processor cause the processor to receive one or more remote operations commands via a communications system included in a vehicle system. The instructions further cause the processor to execute, via a control system included in the vehicle system, a speed control system to control a speed of the vehicle system. The instructions also cause the processor to execute, via the control system, an automatic adjustment teleoperations system to derive a filtered speed command based on the one or more remote operations commands and at least one sensor, and to adjust, via the control system, the speed of the vehicle system based on the filtered speed command.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a teleoperated vehicle operating within an agricultural field;

FIG. 2 is a block diagram of an embodiment of computing systems for the agricultural vehicle of FIG. 1, and for a remote operations system; and

FIG. 3 is a flowchart of an embodiment of a process suitable for assisted teleoperations of the vehicle of FIG. 1.

### DETAILED DESCRIPTION

Certain agricultural and other operations (mining, construction, and the like) may use an unmanned and/or manned vehicle such as a tractor or other vehicle. For agricultural operations, the vehicle may tow or include an agricultural implement such as a planter, seeder, fertilizer, and so on. In operations, the vehicle uses a map suitable for defining field boundaries, driving paths, and the like. The vehicle may operate in unmanned modes based on remote input received, for example, from a remote station. The vehicles described herein may include automatic vehicle systems that enhance remote operations. In teleoperation modes, a vehicle may use human input transmitted from a remote location. However, in certain embodiments, a human may work on the vehicle's cab based on inputs received (e.g., camera views, global positioning system (GPS), sensor input) and apply slightly erroneous throttle inputs (e.g., speed control), steering inputs, and/or braking inputs, for example, because of communications lag. The techniques described herein include an automatic adjustment teleoperations system and process for adjusting vehicle teleoperations.

For example, the automatic adjustment teleoperations system may use certain vehicle protection systems included in the vehicle, such as automatic braking systems, collision avoidance systems, rollover avoidance systems, and the like. Commands may be captured via input devices such as a joystick, the commands may then pass through a command filter that may compare the commands to what is being derived via the vehicle protection systems. The vehicle protection systems may include a variety of onboard sensors, such as laser sensors, stereo vision sensors, distance sensors, radar, and so on. The automatic adjustment teleoperations system may verify in real-time if the commands may cause the vehicle to exhibit unwanted behavior such as collisions, rollovers, braking issues, and so on, and then act to prevent or ameliorate the unwanted behavior.

For example, if the joystick is transmitting a forward command, and the joystick is accidentally pushed to 100%, the teleoperated vehicle would normally follow the joystick forward 100% command unless there was an obstacle. If no obstacle is detected, such as when loading the vehicle onto a trailer, following the unfiltered command may lead to undesired conditions. The techniques described herein may determine that the vehicle is in certain states, such as being loaded onto a trailer, and adjust monitoring via the vehicle protection systems based on this determination. For example, if the joystick is intended to be at forward at 20% and it is accidentally pushed to 100%, the knowledge of the entire state of the vehicle may be used to filter the command and move at a slower speed, e.g., because of the trailer environment. By applying the techniques described herein, more efficient and improved teleoperations of remote vehicles may be achieved.

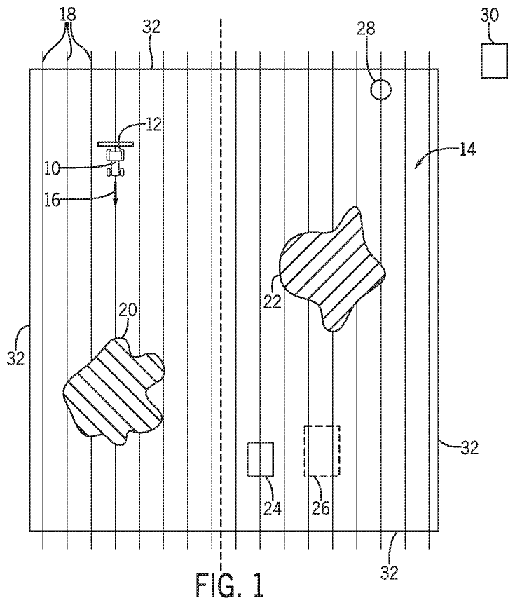

Turning now to FIG. 1, the figure is a schematic diagram of an embodiment of a teleoperated vehicle 10 towing an agricultural implement 12 within an agricultural field 14. The teleoperated vehicle may additionally include in-vehicle cab suitable for human operation. That is, in addition to teleoperations, the vehicle may be driven by a driver inside of the cab. The vehicle may also include automatic steering (e.g., autoguidance), where a human operator may ride in the cab operating throttle and brakes while the vehicle 10 steers automatically. While in the depicted embodiment, the vehicle 10 is depicted as an agricultural tractor, in other embodiments, the vehicle 10 may be a construction vehicle, a mining vehicle, a passenger vehicle, or the like. The tractor 10 or other prime mover is configured to tow the agricultural implement 12 throughout the field 14 along a direction of travel 16. In certain embodiments, the tractor 10 is steered (e.g., via a teleoperator, in-vehicle operator, or an automated system) to traverse the field along substantially parallel rows 18. However, it should be appreciated that the tractor 10 may be steered to traverse the field along other routes (e.g., along a spiral paths, curved paths, obstacle avoidance paths, and so on) in alternative embodiments. As will be appreciated, the agricultural implement 12 may be any suitable implement for performing agricultural operations throughout the field 14. For example, in certain embodiments, the agricultural implement 12 may be a tillage tool, a fertilizer application tool, a seeding or planting tool, or a harvesting tool, among others. While the agricultural implement 12 is towed by the tractor 10 in the illustrated embodiment, it should be appreciated that in alternative embodiments, the agricultural implement may be integrated within the tractor 10. As described earlier, it should be noted that the techniques describe herein may be used for operations other than agricultural operations. For example, mining operations, construction operations, automotive operations, and so on.

As the tractor 10 and the agricultural implement 12 traverse the field, the tractor 10 and the agricultural implement 12 may encounter various field and/or soil conditions, as well as certain structures. Such field and/or soil conditions and structures may be defined as features for purposes of the description herein. For example, the tractor 10 and the agricultural implement 12 may encounter features such as a pond 20, a tree stand 22, a building, fence, or other standing structure 24, transport trailer 26, and miscellaneous features 28 and so on. The miscellaneous features 28 may include water pumps, above ground fixed or movable equipment (e.g. irrigation equipment, planting equipment), and so on. In certain embodiments, the tractor 10 is configured to operate tele-remotely (e.g., without an operator present in the cab of the off-road vehicle). Accordingly, a steering system may steer the tractor 10 and agricultural implement 12 throughout the field with control inputs from a remote operator, for example located at a remote operations control system 30. The remote operations control system 30 may be located geographically distant from the vehicle system 10.

The remote operations control system 30 may be communicatively coupled to the tractor 10 to provide for control instructions (e.g., wireless control) suitable for operating on the field 14. The field 14 may include a field boundary 32, as well as the various features, such as the pond 20, the tree stand 22, the building or other standing structure 24, the transport trailer 26, wet areas of the field 14 to be avoided, soft areas of the field to be avoided, the miscellaneous features 28, and so on. As the tractor 10 operates, the operator may steer to follow a desired pattern (e.g., up and down the field) as well as to avoid obstacles. However, communication delays between the vehicle 10 and the remote operations control system 30 may result in unwanted control inputs. Accordingly, an automatic adjustment teleoperations system may be provided, either included in a vehicle control system, in an external system such as the remote operations control system 30, or in a combination thereof. The teleoperations may apply certain steering inputs, throttle inputs, braking inputs, and the like described in more detail below to adjust or otherwise correct the remote inputs from the remote operations control system 30 to provide for improved driving and control of the tractor 10, as discussed in detail below,

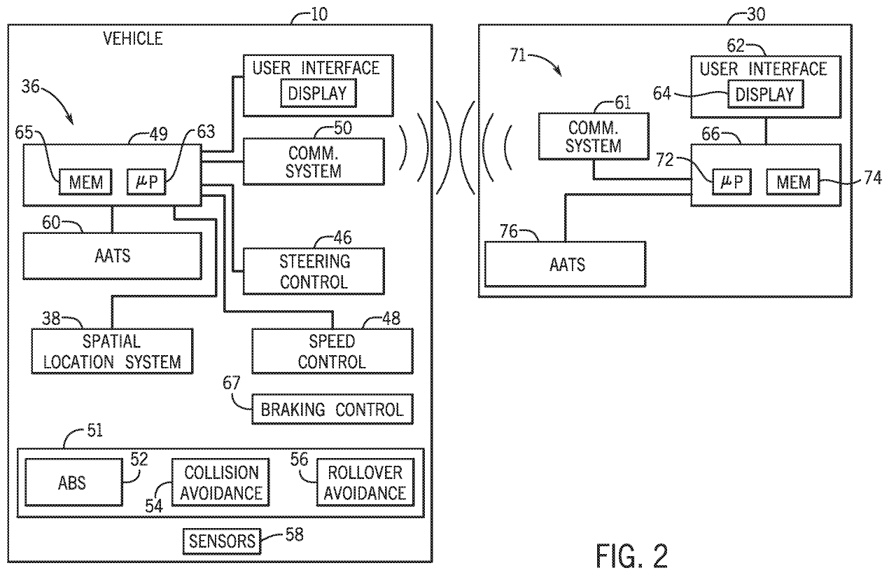

It may be useful to illustrate a system that may be used to both remotely drive the agricultural vehicle 10 as well as to adjust remote inputs sent to the agricultural vehicle 10. Accordingly, and turning now to FIG. 2, the figure is a schematic diagram of an embodiment of a control system 36 that may be employed to control operations of the agricultural vehicle 10 of FIG. 1. In the illustrated embodiment, a control system 36 includes a spatial location system 38, which is mounted to the agricultural vehicle 10 and configured to determine a position, and in certain embodiments a velocity, of the agricultural vehicle 10. As will be appreciated, the spatial location system 38 may include any suitable system configured to measure and/or determine the position of the autonomous agricultural vehicle 10, such as a global positioning system (GPS) receiver, for example, and/or GLONASS or other similar system. The spatial location system 38 may additionally use real time kinematic (RTK) techniques to enhance positioning accuracy.

In the illustrated embodiment, the control system 36 includes a steering control system 46 configured to control a direction of movement of the agricultural vehicle 10, and a speed control system 48 configured to control a speed of the agricultural vehicle 10. In addition, the control system 36 includes a controller 49, which is communicatively coupled to the spatial locating device 38, to the steering control system 46, and to the speed control system 48. The controller 49 is configured to receive inputs via a communications system 50 to control the agricultural vehicle during certain phases of agricultural operations. The controller 49 may also be operatively coupled to certain vehicle protection systems 51, such as an automatic braking system 52, a collision avoidance system 54, a rollover avoidance system 56, and so on. The vehicle protection systems 51 may be communicatively coupled to one or more sensors 58, such as cameras, radar, stereo vision, distance sensors, lasers, inclinometers, acceleration sensors, speed sensors, and so on, suitable for detecting objects, distances to objects, speeds, temperatures, vehicle inclination (e.g., slope), and the like. The sensors 58 may also be used by the controller 49 for driving operations, for example, to provide for collision information, speed, acceleration, braking information, and the like.

Also shown is an automatic adjustment teleoperations system 60 that may filter driving commands incoming from the remote operations control system 30. More specifically, the automatic adjustment teleoperations system 60 may use the sensors 68 and/or the vehicle protection systems 51 to determine a state of the vehicle and to then adjust the driving commands that may be received by the vehicle 10. For example, if a joystick is intended to be at forward at 20% and an operator using the remote operations control system 30 accidentally pushes the joystick to 100%, the knowledge of the entire state of the vehicle 10 may be used to filter the incoming move forward command and move at a slower speed, e.g., because of the operational environment sensed via the sensors 68. The adjustment teleoperations system 60 may also receive inputs from the vehicle protection systems 51 to filter commands. For example, the vehicle protection systems 51 may give indications of upcoming collisions, and so on, and the automatic adjustment teleoperations system 60 may use such indications to update the incoming command from the remote operations control system 30. In certain embodiments, the vehicle protection systems 51 may override the automatic adjustment teleoperations system 60, for example, for collision avoidance, rollover avoidance, prevent brake lock, and so on.

In certain embodiments, the controller 49 is an electronic controller having electrical circuitry configured to process data from the spatial locating device 38, the vehicle protection systems 51, the sensors 68, and/or other components of the control system 36. In the illustrated embodiment, the controller 49 includes a processor, such as the illustrated microprocessor 63, and a memory device 65. The controller 49 may also include one or more storage devices and/or other suitable components. The processor 63 may be used to execute software, such as software for controlling the agricultural vehicle, software for determining vehicle orientation, software to perform steering calibration, and so forth. Moreover, the processor 63 may include multiple microprocessors, one or more “general-purpose” microprocessors, one or more special-purpose microprocessors, and/or one or more application specific integrated circuits (ASICS), or some combination thereof. For example, the processor 63 may include one or more reduced instruction set (RISC) processors.

The memory device 65 may include a volatile memory, such as random access memory (RAM), and/or a nonvolatile memory, such as read-only memory (ROM). The memory device 65 may store a variety of information and may be used for various purposes. For example, the memory device 65 may store processor-executable instructions (e.g., firmware or software) for the processor 63 to execute, such as instructions for controlling the agricultural vehicle, instructions for determining vehicle orientation, and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the agricultural vehicle, etc.), and any other suitable data.

In certain embodiments, the steering control system 46 may rotate one or more wheels and/or tracks of the agricultural vehicle (e.g., via hydraulic actuators) to steer the agricultural vehicle along a desired route (e.g., as guided by a remote operator using the remote operations control system 30). By way of example, the wheel angle may be rotated for front wheels/tracks, rear wheels/tracks, and/or intermediate wheels/tracks of the agricultural vehicle, either individually or in groups. A braking control system 67 may independently vary the braking force on each lateral side of the agricultural vehicle to direct the agricultural vehicle along a path. Similarly, torque vectoring may be used differentially apply torque from an engine to wheels and/or tracks on each lateral side of the agricultural vehicle, thereby directing the agricultural vehicle along a path. In further embodiments, the steering control system 46 may include other and/or additional systems to facilitate directing the agricultural vehicle along a path through the field.

In certain embodiments, the speed control system 48 may include an engine output control system, a transmission control system, or a combination thereof. The engine output control system may vary the output of the engine to control the speed of the agricultural vehicle. For example, the engine output control system may vary a throttle setting of the engine, a fuel/air mixture of the engine, a timing of the engine, other suitable engine parameters to control engine output, or a combination thereof. In addition, the transmission control system may adjust gear selection within a transmission to control the speed of the agricultural vehicle. Furthermore, the braking control system may adjust braking force, thereby controlling the speed of the agricultural vehicle. In further embodiments, the speed control system may include other and/or additional systems to facilitate adjusting the speed of the agricultural vehicle.

The systems 46, 48, and/or 67 may be remotely controlled by the remote operations control system 30. That is, a human operator may use the remote operations control system 30 to control or otherwise drive the vehicle 10 remotely. It is to be noted that remote control may include control from a location geographically distant to the vehicle 10 but may also include control where the human operator may be besides the vehicle 10 and may observe the vehicle 10 locally during operations.

In certain embodiments, the control system 36 may also control operation of the agricultural implement 12 coupled to the agricultural vehicle 10. For example, the control system 36 may include an implement control system/implement controller configured to control a steering angle of the implement 12 (e.g., via an implement steering control system having a wheel angle control system and/or a differential braking system) and/or a speed of the agricultural vehicle/implement system 12 (e.g., via an implement speed control system having a braking control system). In such embodiments, the control system 36 may be communicatively coupled to the implement control system/controller on the implement 12 via a communication network, such as a controller area network (CAN bus). Such control may also be provided remotely via the remote operations control system 30.

In the illustrated embodiment, the control system 36 includes a user interface 54 communicatively coupled to the controller 49. The user interface 54 is configured to enable an operator (e.g., standing proximate or inside the agricultural vehicle) to control certain parameter associated with operation of the agricultural vehicle. For example, the user interface 54 may include a switch that enables the operator to configure the agricultural vehicle for or manual operation. In addition, the user interface 54 may include a battery cut-off switch, an engine ignition switch, a stop button, or a combination thereof, among other controls. In certain embodiments, the user interface 54 includes a display 56 configured to present information to the operator, such as a visual representation of certain parameter(s) associated with operation of the agricultural vehicle (e.g., fuel level, oil pressure, water temperature, etc.), a visual representation of certain parameter(s) associated with operation of an implement coupled to the agricultural vehicle (e.g., seed level, penetration depth of ground engaging tools, orientation(s)/position(s) of certain components of the implement, etc.), or a combination thereof, In certain embodiments, the display 56 may include a touch screen interface that enables the operator to control certain parameters associated with operation of the agricultural vehicle and/or the implement.

In the illustrated embodiment, the control system 36 may include manual controls configured to enable an operator to control the agricultural vehicle while remote control is disengaged. The manual controls may include manual steering control, manual transmission control, manual braking control, or a combination thereof, among other controls. In the illustrated embodiment, the manual controls are communicatively coupled to the controller 49. The controller 49 is configured to disengage automatic control of the agricultural vehicle upon receiving a signal indicative of manual control of the agricultural vehicle. Accordingly, if an operator controls the agricultural vehicle manually, the automatic control terminates, thereby enabling the operator to control the agricultural vehicle.

In the illustrated embodiment, the control system 36 includes the communications system 50 communicatively coupled to the controller 44. In certain embodiments, the communications system 50 is configured to establish a communication link with a corresponding communications system 61 of the remote operations control system 30, thereby facilitating communication between the remote operations control system 30 and the control system 36 of the autonomous agricultural vehicle. For example, the remote operations control system 30 may include a control system 71 having a user interface 62 having a display 64 that enables a remote operator to provide instructions to a controller 66 (e.g., instructions to initiate control of the agricultural vehicle 10, instructions to remotely drive the agricultural vehicle, instructions to direct the agricultural vehicle along a path, instructions to command the steering control 46, braking control 67, and/or speed control 48, instructions to, etc.). For example, joysticks, keyboards, trackballs, and so on, may be used to provide the user interface 62 with inputs used to then derive commands to control or otherwise drive the vehicle 10 remotely.

In the illustrated embodiment, the controller 66 includes a processor, such as the illustrated microprocessor 72, and a memory device 74. The controller 66 may also include one or more storage devices and/or other suitable components. The processor 72 may be used to execute software, such as software for controlling the agricultural vehicle 10 remotely, software for determining vehicle orientation, software to perform steering calibration, and so forth. Moreover, the processor 72 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) processors.

The memory device 74 may include a volatile memory, such as random access memory (RAM), and/or a nonvolatile memory, such as read-only memory (ROM). The memory device 74 may store a variety of information and may be used for various purposes. For example, the memory device 74 may store processor-executable instructions (e.g., firmware or software) for the processor 72 to execute, such as instructions for controlling the agricultural vehicle 10 remotely, instructions for determining vehicle orientation, and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the agricultural vehicle, mapping software or firmware, etc.), and any other suitable data.

The communication systems 50, 61 may operate at any suitable frequency range within the electromagnetic spectrum. For example, in certain embodiments, the communication systems 50, 61 may broadcast and receive radio waves within a frequency range of about 1 GHz to about 10 GHz. In addition, the communication systems 50, 61 may utilize any suitable communication protocol, such as a standard protocol (e.g., Wi-Fi, Bluetooth, etc.) or a proprietary protocol.

In certain embodiments, a second AATS system 76 may also be provided in the control system 71. That is, data, from example from the sensors 58 and/or vehicle protection systems 51 may be transmitted to the remote operations control system 30 to be processed by the second AATS 76 system to also filter user inputs that remote control the vehicle 10 as described above. In some cases, such as when the vehicle 10 is operated in visual line of sight to the remote operator, the AATS system 76 may be used on its own without using on the first AATS system 60. In embodiments where visual line of sight may not be available to the vehicle 10 during remote control, the first AATS system 60 may be used on its own.

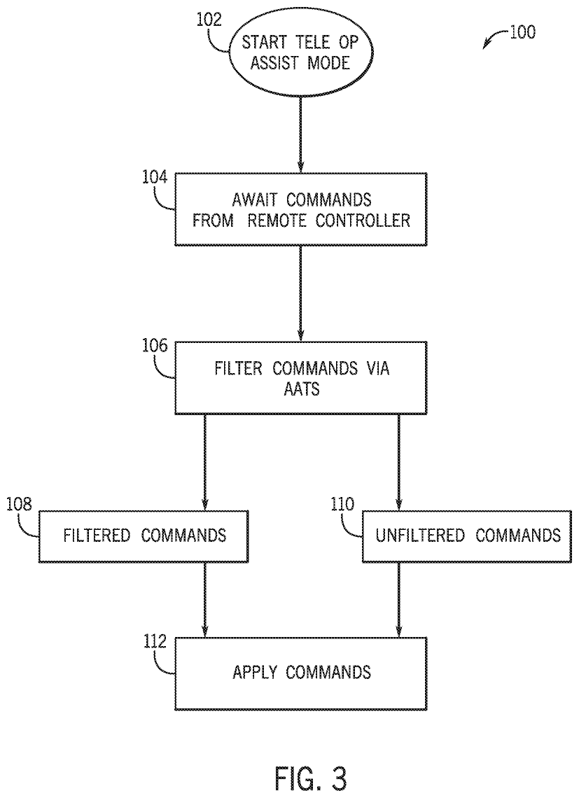

FIG. 3 illustrates a flowchart of an embodiment of a process 100 suitable for remote control of the vehicle 10. The process 100 may be implemented as computer instructions or code executable via the processors 63, 72 and stored in the memories 65, 74. In the depicted embodiment, the process 100 may first start (block 102) a teleoperations assist mode that may engage the AATS 60 and/or 76.

The process 100 may then await (block 104) one or more remote operations commands incoming via the remote control system 30. The one or more remote operations commands may then be filtered (block 106) by the AATS 60 and/or 76. For example, the AATS 76 may be used during line of sight operations, while the AATS 60 may be used when a certain latency is experienced between the communication systems 50, 61.

To filter incoming commands, the AAATS 60 and/or 76 may use the sensors 58 and/or outputs form the vehicle protection systems 51 to determine certain vehicle states. For example, when the vehicle 10 is near a trailer, a state of low speed may be determined. Likewise, low speed states may be determined when the vehicle 10 is near obstacles, near other vehicles, and so on. Some of the remote operations commands may result in filtered commands 108. For example, if a joystick is intended to be at forward at 20% and an operator using the remote operations control system 30 accidentally pushes the joystick to 100%, the knowledge of the entire state of the vehicle 10 may be used to filter the incoming move forward command 100% into a move forward command 20% due to detection of the trailer environment or obstacles detected. In some embodiments, no brakes may need to be applied but simply the filtered command 108 may result in less throttle. In other embodiments, brakes may be used, alone or in combination with less throttle, to slow the vehicle 10. Other filtered commands may include steering commands, braking commands, agricultural implement commands, or a combination thereof. For example, steering motions when an operator inadvertently causes oversteer may be reduced, likewise, overbraking may be reduced.

It is to be noted that in some cases the filtering (block 106) may result in unfiltered commands 110 being issued. For example, if the AATS system 60 and/or 76 determines that the vehicle is in a state that does not require filtering, e.g., in an open field, no nearby obstacles, and so on, then the incoming remote command may not be filtered, resulting in unfiltered commands 110. The commands 108 and/or 110 may then be processed by the control system 36 to remotely operate the vehicle, e.g., by engaging the steering control 46, the speed control 48, and/or the braking control 67. In this manner, an assisted teleoperations mode may be provided. Further, a manual override may be used. For example, sensor errors and/or other circumstances may then be handled via the manual override.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a vehicle system, comprising:
at least one sensor;
a communications system configured to receive one or more remote operations commands;
a control system configured to:
execute a speed control system to control a speed of the vehicle system;
execute an automatic adjustment teleoperations system to derive a filtered speed command based on the one or more remote operations commands and the at least one sensor; and
adjust the speed of the vehicle system based on the filtered speed command.

2. The system of claim 1, wherein the adjustment teleoperations system is configured to derive the filtered speed command by sensing a state of the vehicle system via inputs from the at least one sensor.

3. The system of claim 2, wherein sensing the state of the vehicle system comprises sensing that the vehicle system is in a reduced speed environment.

4. The system of claim 3, wherein the one or more remote operations commands comprises a command to move the vehicle system at a first speed and wherein the filtered command comprises a command to move the vehicle system at a second speed slower than the first speed.

5. The system of claim 4, wherein the control system is configured to adjust the speed of the vehicle based on the second speed without applying brakes.

6. The system of claim 1, wherein the control system is configured to execute the automatic adjustment teleoperations system to derive a filtered braking command, a filtered steering command, or a combination thereof, based on the on the one or more remote operations commands and the at least one sensor, to adjust the speed of the vehicle system based on the filtered braking command, and to adjust a steering of the vehicle system based on the filtered steering command, or a combination thereof.

7. The system of claim 1, comprising a remote control system configured to transmit the one or more remote operations commands.

8. The system of claim 7, wherein the remote control system comprises a remote automatic adjustment teleoperations system configured to derive a second filtered speed command based on a user command to move the vehicle system, and to transmit the second filtered speed command to the vehicle system.

9. The system of claim 8, wherein the control system is configured to adjust the speed of the vehicle system based on the filtered speed command, the second filtered speed command, or a combination thereof, based on a latency of communication.

10. A method, comprising:
receiving one or more remote operations commands via a communications system included in a vehicle system;
executing, via a control system included in the vehicle system, a speed control system to control a speed of the vehicle system;
executing, via the control system, an automatic adjustment teleoperations system to derive a filtered speed command based on the one or more remote operations commands and at least one sensor; and
adjusting, via the control system, the speed of the vehicle system based on the filtered speed command.

11. The method of claim 10, wherein the adjustment teleoperations system is configured to derive the filtered speed command by sensing a state of the vehicle system via inputs from the at least one sensor.

12. The method of claim 11, wherein sensing the state of the vehicle system comprises sensing that the vehicle system is in a reduced speed environment.

13. The method of claim 10, comprising executing the automatic adjustment teleoperations system to derive a filtered braking command, a filtered steering command, or a combination thereof, based on the on the one or more remote operations commands and the at least one sensor, and adjusting the speed of the vehicle system based on the filtered braking command, adjusting a steering of the vehicle system based on the filtered steering command, or a combination thereof.

14. The method of claim 10, comprising transmitting the one or more remote operations commands to the communications system via a remote control system.

15. The method of claim 10, wherein the remote control system comprises a remote automatic adjustment teleoperations system configured to derive a second filtered speed command based on a user command to move the vehicle system, and to transmit the second filtered speed command to the vehicle system.

16. A non-transitory, computer readable medium comprising instructions that when executed by a processor cause the processor to:
receive one or more remote operations commands via a communications system included in a vehicle system;
execute, via a control system included in the vehicle system, a speed control system to control a speed of the vehicle system;
execute, via the control system, an automatic adjustment teleoperations system to derive a filtered speed command based on the one or more remote operations commands and at least one sensor; and
adjust, via the control system, the speed of the vehicle system based on the filtered speed command.

17. The non-transitory, computer readable medium of claim 16, wherein the adjustment teleoperations system is configured to derive the filtered speed command by sensing a state of the vehicle system via inputs from the at least one sensor.

18. The non-transitory, computer readable medium of claim 16, wherein sensing the state of the vehicle system comprises sensing that the vehicle system is in a reduced speed environment.

19. The non-transitory, computer readable medium of claim 18, comprising instructions that when executed by the processor, cause the processor to execute the automatic adjustment teleoperations system to derive a filtered braking command, a filtered steering command, or a combination thereof, based on the on the one or more remote operations commands and the at least one sensor, and to adjust the speed of the vehicle system based on the filtered braking command, adjust a steering of the vehicle system based on the filtered steering command, or a combination thereof.

20. The non-transitory, computer readable medium of claim 16, comprising instructions that when executed by the processor, cause the processor to transmit the one or more remote operations commands to the communications system via a remote control system.
